(19) United States
(12) Patent Application Publication
(10) Pub. No.: US 2002/0053796 A1
(43) Pub. Date: May 9, 2002

(54) Graphical label and method of manufacturing

(76) Inventors: Mark McCann, Carrollton, TX (US); Tamaris McCann, Carrollton, TX (US)

Correspondence Address: Robert W. Mason, Esq., Jenkens & Gilchrist, P.C., 1445 Ross Avenue, Suite 3200, Dallas, TX, 75202-2799, US

(21) Appl. No.: 10/008,262

(22) Filed: Nov. 7, 2001

Related U.S. Application Data
(60) Provisional application No. 60/247,044, filed on Nov. 7, 2000.

(51) Int. Cl. B42D 15/00

(52) U.S. Cl. 283/74

(57) ABSTRACT

The present invention is generally directed to a label having graphical marks, graphical logos or other brand identifiers for easy product association and identification in a commercial environment, and a method of manufacturing the same. A label in accordance with an embodiment of the present invention includes a first section onto which a graphical mark, graphical logo, or other brand identifier is printed. The label may also I include sections onto which textual description information, price/quantity/specific property information, and a Universal Product Code (UPC) may be printed.

### BACKGROUND OF THE PRESENT INVENTION

1. Field of the Invention

The present invention generally relates to a label and method for manufacturing same, and more particularly but not by way of limitation, to a label having graphical logos or brand identifiers for easy product association and identification in a commercial environment and method of manufacturing thereof.

2. Description of Related Art

Product labeling technology has traditionally involved the use of handwritten or printed labels to identify a particular product on a display shelf. These labels typically include a text description of the product, a barcode associated with the product, and pricing information. The labels are typically attached directly to a display shelf or affixed to price channel chips which are inserted into channels on the display shelf. The problem with traditional labeling methods is that a text-only product description does not provide a means for a purchaser to readily identify the product that the label is associated with. In particular, it is difficult for a purchaser to easily identify a product brand on a traditional product label. In addition, traditional product labels do not provide an aesthetically pleasing identification of the particular product. Finally, these product labels are not adapted for specific efficiency advantages.

### SUMMARY OF THE INVENTION

The present invention provides for a solution of the current problems and other problems associated with product labeling technology by allowing the inclusion of readily identifiable graphical marks, logos, or other brand identifiers onto a product label. In addition, the present invention provides for a more aesthetically attractive presentation of a product label, as well as a more efficient method for producing product labels.

The present invention is generally directed to a label having graphical logos or brand identifiers for easy product association and identification in a commercial environment, and a method of manufacturing the same. A label in accordance with an embodiment of the present invention includes a first section onto which a graphical mark, graphical logo, or other brand identifier is printed. The label can also include sections onto which textual description information, price/quantity/specific property information, and a Universal Product Code (UPC) are printed.

A method of manufacturing a label in accordance with the present invention includes providing a printing means, imprinting a first section of the label with a graphical mark, graphical logo, or other brand identifier using the printing means, printing any additional information onto the label using the printing means, and attaching the label to a display. An alternative method includes affixing the label to a price channel chip and attaching the price channel chip to the display.

Another method of manufacturing a label in accordance with the present invention includes providing an etching means, etching a first section of the label with a graphical mark, graphical logo, or other brand identifier using the etching means, providing a printing means, printing any additional information onto the label using the printing means, and attaching the label to a display. An alternative method includes affixing the label to a price channel chip and attaching the price channel chip to the display.

### BRIEF DESCRIPTION OF THE DRAWINGS

For a more complete understanding of the present invention, reference is made to the following detailed description taken in conjunction with the accompanying drawings wherein:

FIG. 1 illustrates a typical display shelf 10 having a channel for receiving price channel chips;

FIG. 2 illustrates a cross-sectional view of the lower shelf 12 in FIG. 1 taken along a line 2-2;

FIG. 3 illustrates a front elevational view of an enlarged label 20 in accordance with a first embodiment of the present invention;

FIG. 4 illustrates a front elevational view of an enlarged label 30 in accordance with another embodiment of the present invention;

FIG. 5 illustrates a flow chart 50 of a first method for manufacturing a label in accordance with the principles of the present invention;

FIG. 6 illustrates a flow chart 60 of a second method for manufacturing a label in accordance with the principles of the present invention;

FIG. 7 illustrates a flow chart 70 of a third method for manufacturing a label in accordance with the principles of the present invention; and

FIG. 8 illustrates a flow chart 80 of a fourth method for manufacturing a label in accordance with the principles of the present invention.

### DESCRIPTION OF THE INVENTION

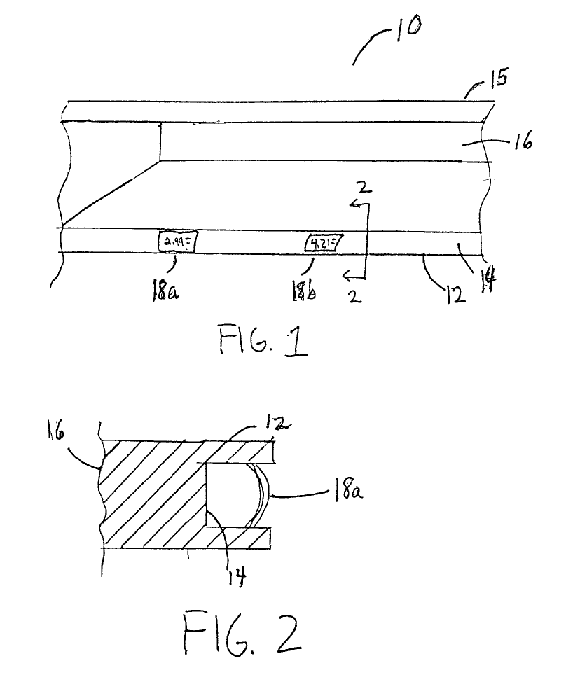

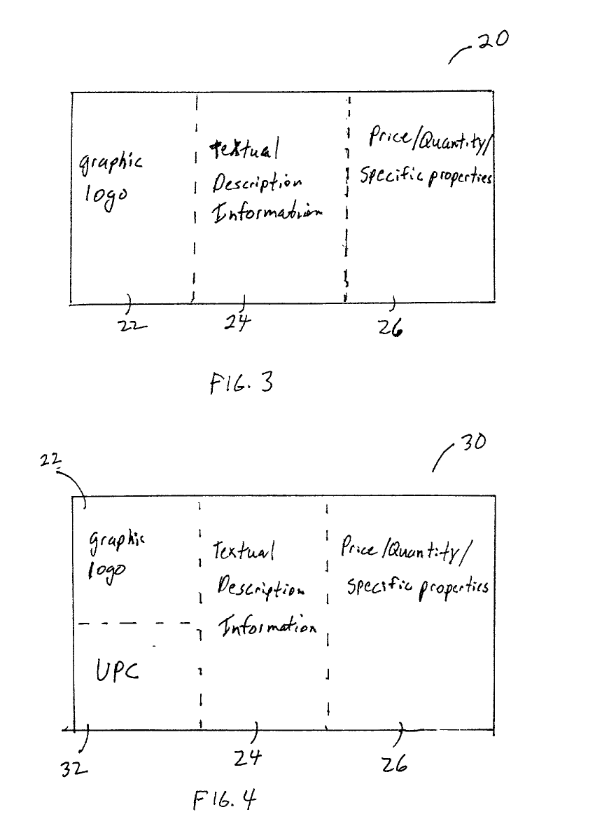

Referring now to FIG. 1, a typical display shelf 10 having a channel for receiving price channel chips is illustrated. The display shelf 10 includes a lower shelf 12 and upper shelf 15 attached to a vertical supporting surface 16. The lower shelf 12 includes a channel 14 into which a number of price channel chips 18a, 18b can be placed. A cross-sectional view of the lower shelf 12 in FIG. 1 taken along line 2-2 is illustrated in FIG. 2. The price channel chips 18a, 18b provide for the mounting or attachment of labels manufactured in accordance with the principles of the present invention. Alternately, the labels may be attached directly to the display without the use of a price channel chip 18a, 18b. The display shelf 10 can be used in a variety of applications such as for displaying products for retail sale or for inventory tracking of items in a commercial environment.

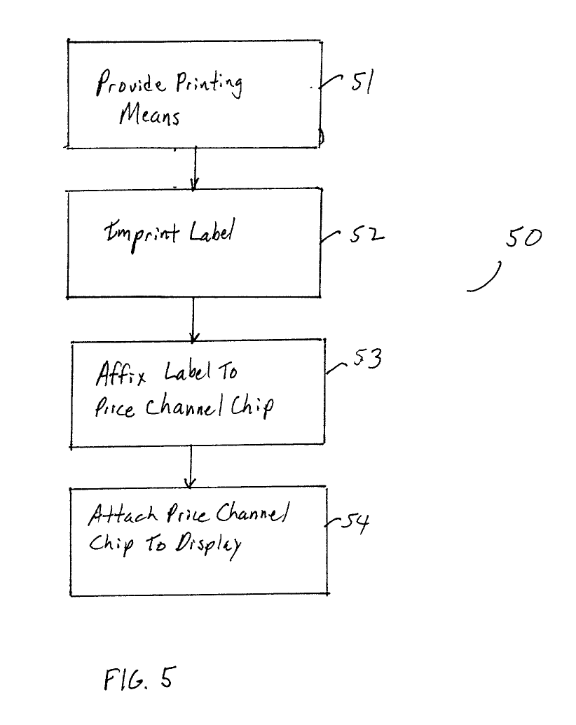

Referring now to FIG. 3, a front elevational view of an enlarged label 20 in accordance with a first embodiment of the present invention is illustrated. The label 20 includes a first section 22 onto which is printed a graphical mark, graphical logo, or other graphical brand identifier. In accordance with an embodiment of the present invention, the graphical mark/logo or brand identifier is in color print, and can comprise a trademarked logo or trademarked brand identifier with the proper permission of the trademark owner. Alternately, black and white print may be used to print the graphical mark/logo or brand identifier. The imprinting of the graphical mark/logo or brand identifier onto the first section 22 allows a viewer of the label 20 to readily identify a particular product or commercial article with which the label 20 is associated, thus allowing for easy product association and identification in a commercial environment. The imprinting of the graphical mark/logo further provides a commercial advantage to owners of certain associated trademarks by exposing this mark in a prominent location to allow product identification.

The label 20 can also include a second section 24 onto which is printed textual or numerical description information for the product or article to be identified by the label 20. In an embodiment of the present invention, the textual description information includes a description of the number of items included with the product or commercial article and the quantity of each item included. For example, the second section 24 on a label 20 for a beverage product may indicate that the product consists of a 12-pack of 12 oz. cans, a 6-pack of bottles, etc. The label 20 also includes a third section 26 onto which is printed textual or numerical price/quantity and other specific property description information for the product to be identified. For example, the price of the particular product can be printed on the third section 26 for display to a purchaser.

It should be understood that labels in accordance with the present invention can be mounted on price channel chips or used as stand-alone labels directly mounted to a display. In addition, the ink used for printing and graphics can comprise any standard ink, however an ink that does not run when exposed to moisture and other unfavorable conditions is desirable. It should also be understood that the positioning of the sections on the label 20 is not significant to the present invention, nor is the number of sections. For example, the label 20 may have as many as one hundred sections and as few as one section containing a graphical depiction of the product mark/logo or brand identifier, depending on the requirements of the application.

Referring now to FIG. 4, a front elevational view of an enlarged label 30 in accordance with another embodiment of the present invention is illustrated. The label 30 includes the aforementioned first section 22, second section 24, and third section 26 as described in relation to FIG. 3. In addition, the label 30 includes a fourth section 32 onto which is printed product identification information, such as Universal Product Code (UPC) information for the particular product. It should be understood that other forms of product identification may be used instead of UPC information, such as a barcode identifier, or a product or article identification number.

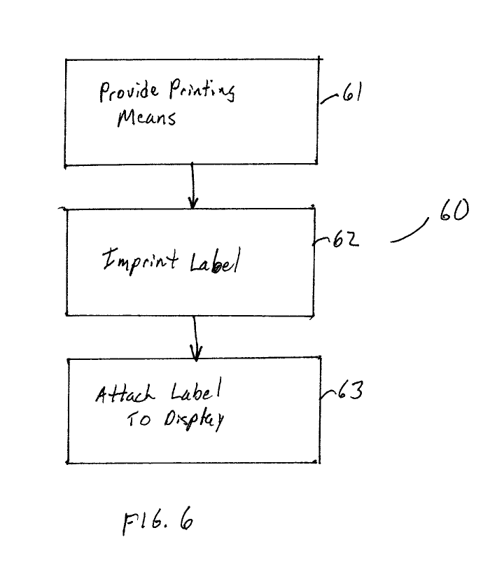

Referring now to FIG. 5, a flow chart 50 of a first method for manufacturing a label in accordance with the principles of the present invention is illustrated. In step 51, a printing means is provided. The printing means can comprise a color laser or ink printer, a silk screen machine, an electronic label printer, or any other sign-making or printing device which may be used to imprint or mark the relevant graphical and textual information onto a label 20, preferably a printing means which produces a non-running quality for the print or mark/logo. In step 52, the printing means is used to imprint the graphical mark, graphical logo, or other brand identifier in the first section 22 of the label 20. Imprinting of the optional additional information in other sections 24, 26, 32 of the label 20, such as textual description information, price/quantity information, UPC information, etc., is also performed in step 52. In step 53, the printed label is affixed to a price channel chip. In step 54, the price channel chip is then attached to a display, such as a display shelf 10. The method for manufacturing a label in accordance with the principles of the present invention can be performed, for example, by an electronic label printing device, such as a portable label printer, or a personal computer printer.

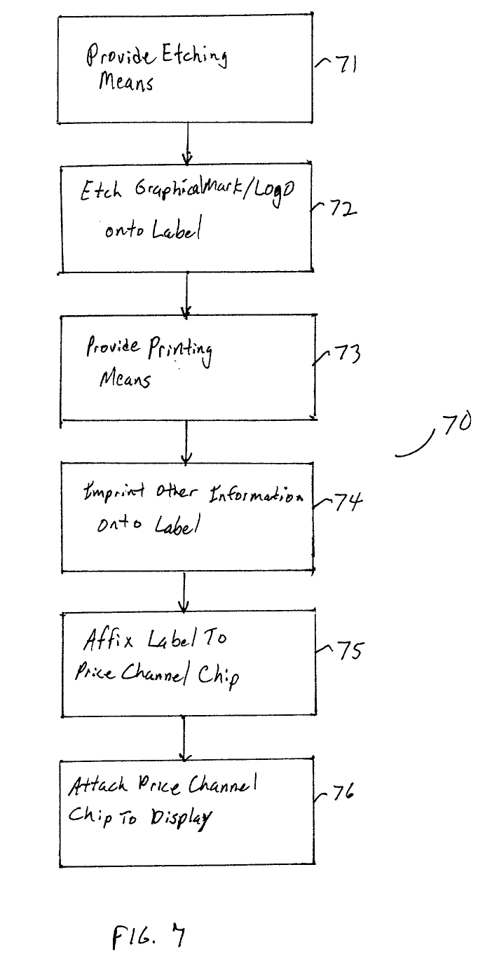

Referring now to FIG. 6, a flow chart 60 of a second method for manufacturing a label in accordance with the principles of the present invention is illustrated. In step 61, a printing means, such as a color laser or ink printer, silk screen machine, or any other sign-making or printing device, is provided. In step 52, the printing means is used to imprint the graphical mark, graphical logo, or other brand identifier in the first section 22 of a label 20. Imprinting of the optional additional information in other sections 24, 26, 32 of the label 20, such as textual description information, price/quantity information, UPC information, etc., is also performed in step 62. In step 63, the label 20 is then attached to a display. The method in accordance with FIG. 6 provides for the use of a stand-alone label that does not require the use of a price channel chip.

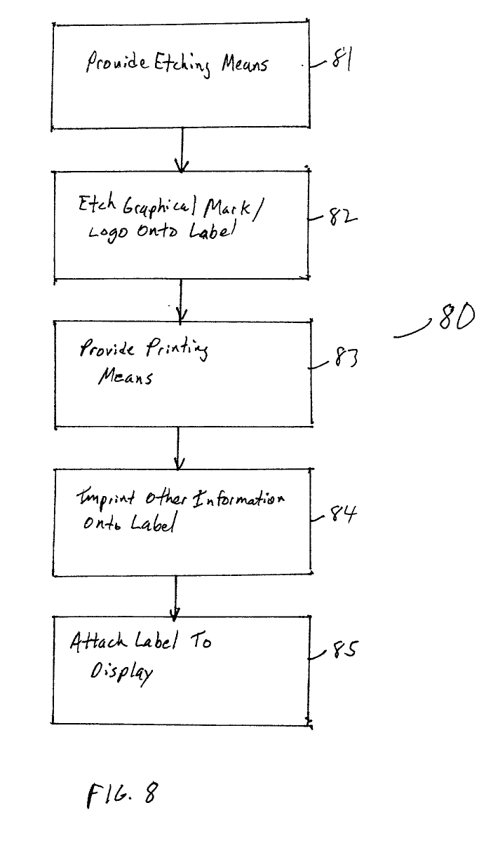

Referring now to FIG. 7, a flow chart 70 of a third method for manufacturing a label in accordance with the principles of the present invention is illustrated. In step 71, an etching means is provided. Then, in step 72, the etching means is used to etch a graphical mark, graphical logo, or other brand identifier onto a first section 22 of a label 20. In step 73, a printing means is provided. In step 74, the printing means is used to imprint other information onto additional sections 24, 26, 32 of the label 20, such as textual description information, price/quantity information, UPC information, etc. In step 75, the printed label is affixed to a price channel chip. In step 76, the price channel chip is then attached to a display, such as a display shelf 10. The use of an etching means to etch the graphical mark, graphical logo, or other brand identifier on the label 20 provides for a brand identifier which is more resistant to moisture and other unfavorable conditions than a printed brand identifier.

Referring now to FIG. 8, a flow chart 80 of a fourth method for manufacturing a label in accordance with the principles of the present invention is illustrated. In step 81, a etching means is provided. In step 82, the etching means is used to etch a graphical mark, graphical logo, or other brand identifier onto a first section 22 of a label 20. In step 83, a printing means is provided. In step 84, the printing means is used to imprint other information onto additional sections 24, 26, 32 of the label 20, such as textual description information, price/quantity information, UPC information, etc. In step 85, the label is then attached to a display, such as a display shelf 10. The method in accordance with FIG. 8 provides for the use of a stand-alone label that does not require the use of a price channel chip.

It should be understood that in the previously described embodiments of the present invention, the providing of a printing means can include selling, distributing, including, offering for sale, advertising, and marketing the printing means. Additionally, it should be understood that the providing of the etching means can include selling, distributing, including, offering for sale, advertising, and marketing the etching means.

It should be understood that other modifications may be made to the embodiments disclosed. For example, a method of imprinting or marking a silk screen and subsequently applying the silk screen onto a plastic chip which is sized to fit on a display shelf may be utilized in certain embodiments. Alternatively, an etching system may be used to etch the mark or logo onto the plastic chip, or onto a silk screen which is then applied onto the plastic chip.

The present invention provides for a solution of the current problems and other problems associated with product labeling technology by allowing the inclusion of readily identifiable graphical marks, logos, or other brand identifiers onto a product label. An additional benefit of the present invention includes the provision for a more aesthetically attractive presentation of a product label. Still another benefit of the present invention includes the provision of increased efficiency for printing product labels by allowing a large number of labels to be manufactured in a short amount of time.

Although a preferred embodiment of the method and apparatus of the present invention has been illustrated in the accompanying Drawings and described in the foregoing Detailed Description, it is understood that the invention is not limited to the embodiment disclosed, but is capable of numerous rearrangements, modifications, and substitutions without departing from the spirit of the invention as set forth and defined by the following claims.

What is claimed is:

1. A label for the identification of a commercial article, said label comprising:
a first section, said first section including a graphical brand identifier associated with the commercial article.

2. The label of claim 1, wherein said graphical brand identifier is a color graphical brand identifier.

3. The label of claim 1, wherein said graphical brand identifier is a black and white graphical brand identifier.

4. The label of claim 1, wherein said graphical brand identifier is at least one of a graphical mark, graphical logo, and a trademarked brand identifier.

5. The label of claim 1, said label further comprising:
a second section, said second section including description information associated with the commercial article.

6. The label of claim 5, wherein said description information comprises at least one of a number of items included with the commercial article, and a quantity of each item included with the commercial article.

7. The label of claim 1, said label further comprising:
a third section, said third section including specific property description information associated with the commercial article.

8. The label of claim 1, wherein said specific property description information includes at least one of a price of the commercial article, and a quantity of the commercial article.

9. The label of claim 1, said label further comprising:
a fourth section, said fourth section including an article identification number associated with the commercial article.

10. A method for manufacturing a label used for the identification of a commercial article, said method comprising:
providing a printing means; and
imprinting, using said printing means, a graphical brand identifier associated with the commercial article onto a first section of said label.

11. The method of claim 10, said method further comprising at least one of:
attaching said label to a display; and
affixing said label to a price channel chip.

12. The method of claim 10, said method further comprising:
imprinting, using said printing means, other information associated with the commercial article onto a at least one other section of said label.

13. The method of claim 12, wherein said other information includes at least one of description information associated with the commercial article, specific property information associated with the commercial article, and an article identification number associated with the commercial article.

14. The method of claim 10, wherein said printing means comprises at least one of a laser printer, an ink printer, a silk screen machine, an electronic label printer, and a sign-making device.

15. The method of claim 10, wherein said providing includes at least one of the following:
selling, distributing, including, offering for sale, advertising, and marketing.

16. A method for manufacturing a label used for the identification of a commercial article, said method comprising:
providing an etching means; and
etching, using said etching means, a graphical brand identifier associated with the commercial article onto a first section of said label.

17. The method of claim 16, said method further comprising:
providing a printing means; and
imprinting, using said printing means, other information associated with the commercial article onto a at least one other section of said label.

18. The method of claim 17, wherein said other information includes at least one of description information associated with the commercial article, specific property information associated with the commercial article, and an article identification number associated with the commercial article.

19. The method of claim 16, said method further comprising at least one of:
attaching said label to a display; and
affixing said label to a price channel chip.

20. The method of claim 16, wherein said providing includes at least one of the following:
selling, distributing, including, offering for sale, advertising, and marketing.
